(19) United States
(12) Patent Application Publication
(10) Pub. No.: US 2017/0288898 A1
(43) Pub. Date: Oct. 5, 2017

(54) NON-TRANSITORY COMPUTER READABLE MEDIUM, SIGNAL ACCOMMODATION METHOD, AND SIGNAL ACCOMMODATION DEVICE

(71) Applicant: FUJITSU LIMITED, Kawasaki-shi (JP)

(72) Inventor: Takuya Sueyoshi, Nisshin (JP)

(73) Assignee: FUJITSU LIMITED, Kawasaki-shi (JP)

(21) Appl. No.: 15/461,960

(22) Filed: Mar. 17, 2017

(30) Foreign Application Priority Data
Mar. 29, 2016 (JP) 2016-066574

(51) Int. Cl. H04L 12/40

(52) U.S. Cl. CPC H04L 12/40006; H04L 2012/40215

(57) ABSTRACT

A non-transitory computer readable medium storing a signal accommodation program that causes a computer to execute a process including: specifying a plurality of signals to be transmitted to nodes connected to a bus from among signals transmitted from any one of one or more nodes connected to a plurality of buses included in a network; and accommodating the plurality of signals into a frame to be transferred on the network.

### CROSS-REFERENCE TO RELATED APPLICATION

This application is based upon and claims the benefit of priority of the prior Japanese Patent Application No. 2016-066574, filed on Mar. 29, 2016, the entire contents of which are incorporated herein by reference.

### FIELD

A certain aspect of embodiments described herein relates to a non-transitory computer readable medium, a signal accommodation method and a signal accommodation device.

### BACKGROUND

For example, a plurality of computers (e.g. 50 to 60 computers) such as ECUs (Electric Control Unit) are installed in a vehicle, and they constitute a network such as a CAN (Controller Area Network) as an on-vehicle LAN (Local Area Network) (e.g. Patent Document 1: Japanese Patent Application Publication No. 2006-319540, and Patent Document 2: Japanese Patent Application Publication No. 2014-204160). The CAN includes a plurality of buses to which one or more computers are connected, and the buses are connected to each other via a gateway.

Moreover, various applications are installed in the computers, respectively, and the applications cooperate to perform processing. Consequently, each computer transmits a signal to another computer via the CAN.

### SUMMARY

According to an aspect of the present invention, there is provided a non-transitory computer readable medium storing a signal accommodation program that causes a computer to execute a process including: specifying a plurality of signals to be transmitted to nodes connected to a bus from among signals transmitted from any one of one or more nodes connected to a plurality of buses included in a network; and accommodating the plurality of signals into a frame to be transferred on the network.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating a CAN and an accommodation example 1 of signals;

FIG. 2 is a block diagram illustrating the CAN and an accommodation example 2 of the signals;

FIG. 3 is a block diagram illustrating the CAN and an accommodation example 3 of the signals;

FIG. 4 is a block diagram illustrating the CAN and an accommodation example 4 of the signals;

FIG. 5 is a block diagram illustrating an example of a signal accommodation device;

FIG. 6A is a diagram illustrating an example of network configuration information;

FIG. 6B is a diagram illustrating an example of signal information;

FIG. 7 is a flowchart illustrating an example of a process of a signal accommodation program;

FIG. 8 is a diagram illustrating an example of a signal list;

FIG. 9 is a diagram illustrating an example of a classification list;

FIG. 10 is a diagram illustrating an example of the classification list in which information on destination buses is corrected;

FIG. 11 is a diagram illustrating an example of a generating process of flame information;

FIG. 12 is a diagram illustrating an example of the generating process of the flame information;

FIG. 13 is a diagram illustrating an example of the generating process of the flame information;

FIG. 14 is a diagram illustrating an example of the generating process of the flame information;

FIG. 15 is a diagram illustrating an example of the generating process of the flame information;

FIG. 16 is a diagram illustrating an example of the generating process of the flame information;

FIG. 17 is a diagram illustrating an example of the generating process of the flame information;

FIG. 18 is a diagram illustrating an example of the generating process of the flame information;

FIG. 19 is a diagram illustrating an example of the generating process of the flame information; and

FIG. 20 is a diagram illustrating an example of the generating process of the flame information.

### DESCRIPTION OF EMBODIMENTS

A signal of each computer is accommodated in a frame in a predetermined format and is transmitted on the network. When each signal is accommodated in an individual frame, the number of the frames increases and hence a load of the network increases. This is noticeable in the case of the network having a low communication speed like the CAN.

A signal accommodation device of an embodiment performs a design to accommodate signals of a CAN installed in a vehicle such as an automobile into a frame. Hereinafter, an accommodation example of the signals is explained.

### ACCOMMODATION EXAMPLE 1

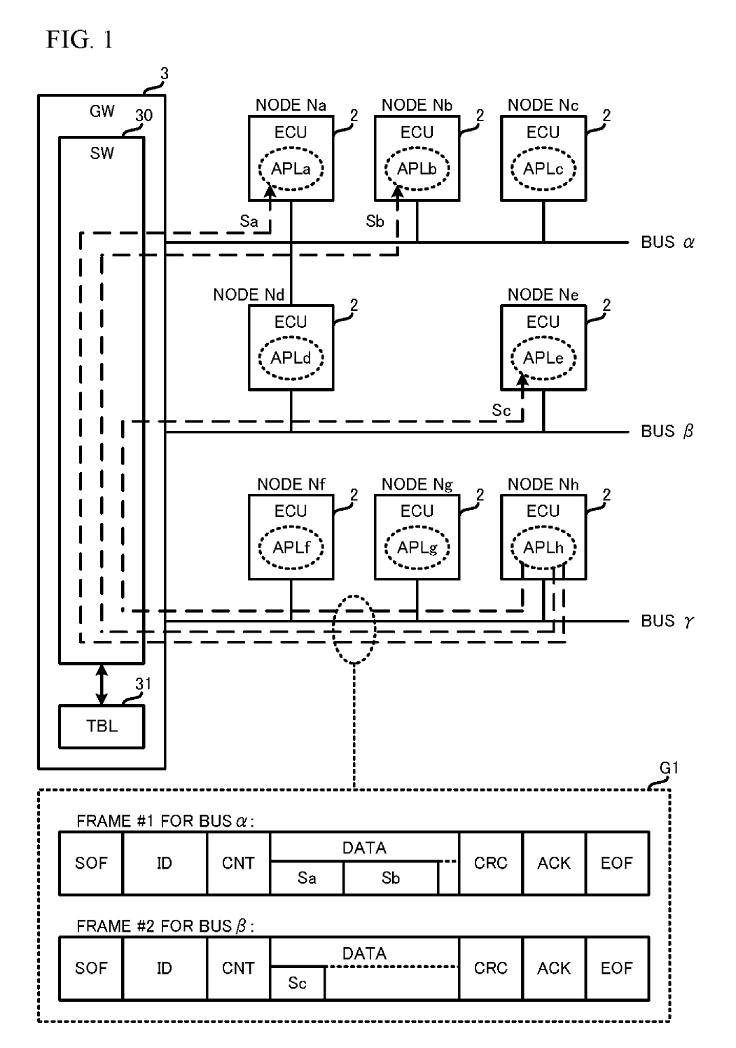

FIG. 1 is a block diagram illustrating a CAN and an accommodation example 1 of signals. The CAN is an example of a network, and includes a plurality of ECUs 2, a plurality of buses α, β and γ to which the ECUs 2 are connected, and a gateway 3. The ECUs 2 are provided in a plurality of nodes Na to Nh in the CAN, respectively, and each of the nodes Na to Nh is connected to any one of the buses α, β and γ.

More specifically, the nodes Na to Nd are connected to the bus α, the nodes Nd and Ne are connected to the bus β, and the nodes Nf to Nh are connected to the bus γ. The node Nd is connected to the two buses α and β. Here, the nodes Na to Nh may be connected to the three buses α, β and γ or more.

Each of the ECUs 2 includes a microcontroller circuit which is an example of a computer. Applications APLa to APLh executing various functions are installed in the ECUs 2, respectively. At least a part of the applications APLa to APLh cooperates with each other and performs a predetermined process. Consequently, each ECU 2 transmits signals Sa to Sc to another ECUs 2 via the CAN.

For example, the ECU 2 of the node Nh transmits the signal Sa to the ECU 2 of the node Na, transmits the signal Sb to the ECU 2 of the node Nb, and transmits the signal Sc to the ECU 2 of the node Ne. Each of the signals Sa to Sc is generated by the application APLh in the ECU 2 of a transmission side. Data on an engine speed is included in the signals Sa to Sc, for example. The applications APLa to APLc in the ECU 2 of a reception side receive the signals Sa to Sc and perform predetermined processes, respectively.

The ECU 2 generates a CAN frame (hereinafter simple referred to as “a frame”) indicated by a code “G1” and accommodates the signals Sa to Sc into the frame. The fame includes a SOF (Start Of Frame) domain indicating a head of the frame, an ID (Identifier) domain indicating contents of the signals Sa to Sc, a transmission source node and a priority, a data domain accommodating the signals Sa to Sc, and a CNT (Control) domain indicating a length of the data domain. When the plurality of ECUs 2 are going to simultaneously transmit the frames, the ECU 2 which can transmit the frame is decided depending on the priority of the ID. Moreover, each ECU 2 identifies the frame addressed to itself based on the ID of the frame to receive the frame.

Moreover, the frame includes a CRC (Cyclic Redundancy Code) domain for the correction of a data error, an ACK (Acknowledgement) domain indicating response timing and an EOF (End Of Frame) domain indicating an end of the frame. Here, when the plurality of applications APLa to APLh are installed in the single ECU 2, the communication between the applications APLa to APLh in the same ECU 2 is performed in the ECU 2, so that the signals Sa to Sc corresponding to the communication are internal signals and are not accommodated into the frame.

The frame is transmitted via the gateway 3 from the bus γ (hereinafter referred to as “a transmission source bus”) to which the ECU 2 of the transmission source node Nh is connected, to the buses α and β to which each ECU 2 of destination nodes Na, Nb and Ne is connected.

The gateway 3 includes a switch (SW) 30 that transfers and receives the frame to/from the buses α, β and γ, and a transfer table (TBL) 31 indicating a correspondence relationship between a value of the ID domain of the frame and the transfer destination buses α, β and γ. When the switch 30 receives the frame, the switch 30 transfers the frame to any one of the buses α, β and γ corresponding to the value of the ID domain of the frame with reference to the TBL 31. Here, the SW 30 is made of a CPU (Central Processing Unit), for example, and the table 31 is stored into a memory.

In the present example, a signal accommodation device selects the signals Sa to Sc transmitted from the node Nh and accommodates the signals into the frame. The signal accommodation device identifies, from the selected signals, the signals having the the same bus connected to the destination node, i.e., the same destination bus, and accommodates the identified signals into a common frame. More specifically, the signal accommodation device accommodates the signals Sa and Sb into a frame #1 for the bus α, and accommodates the signal Sc into a frame #2 for the bus β, as illustrated by the code G1.

Thus, the signal accommodation device identifies the signals Sa and Sb in which the destination nodes are the nodes Na and Nb connected to the same bus α from among the signals Sa to Sc transmitted from the node Nh connected to the bus γ, and accommodates the identified signals Sa and Sb into the same frame.

Consequently, in the present example, the number of frames in the CAN reduces, compared with a case where each of the signals Sa and Sb having the different destination node Na and Nb is accommodated into the individual frame. Therefore, a load of the network is reduced.

### ACCOMMODATION EXAMPLE 2

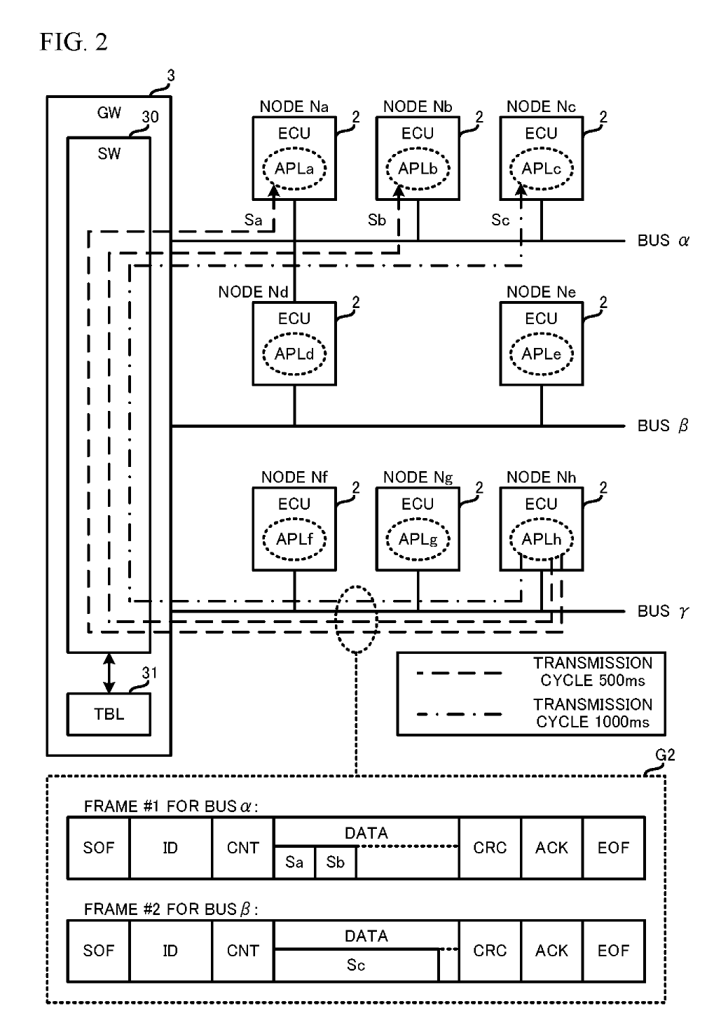

FIG. 2 is a block diagram illustrating the CAN and an accommodation example 2 of the signals. Elements corresponding to those in FIG. 1 are denoted by the same reference numerals, and description thereof is omitted. In the present example, the configuration of the CAN is the same as that of the CAN of the accommodation example 1.

The ECU 2 of the node Nh transmits the signal Sa to the ECU 2 of the node Na in a transmission cycle of 500 (ms), transmits the signal Sb to the ECU 2 of the node Nb in the transmission cycle of 500 (ms), and transmits the signal Sc to the ECU 2 of the node Nc in the transmission cycle of 1000 (ms).

In the present example, the signal accommodation device accommodates the signals having the same destination bus α nd the same transmission cycle into the common frame. More specifically, the signal accommodation device accommodates the signals Sa and Sb having the same destination bus α and the same transmission cycle (500 (ms)) into the common frame #1, and accommodates the signal Sc having the common destination bus α but having the different transmission cycle (1000 (ms)) into another frame #2.

Thus, the signal accommodation device accommodates the signals Sa and Sb having the same transmission cycle into the same frame, among from the signals Sa to Sc in which the destination node is a node connected to the same bus α.

Consequently, the number of frames in the CAN reduces, compared with a case where each of the signals Sa to Sc having the different transmission cycles is accommodated into the individual frame. Therefore, the load of the network is reduced.

### ACCOMMODATION EXAMPLE 3

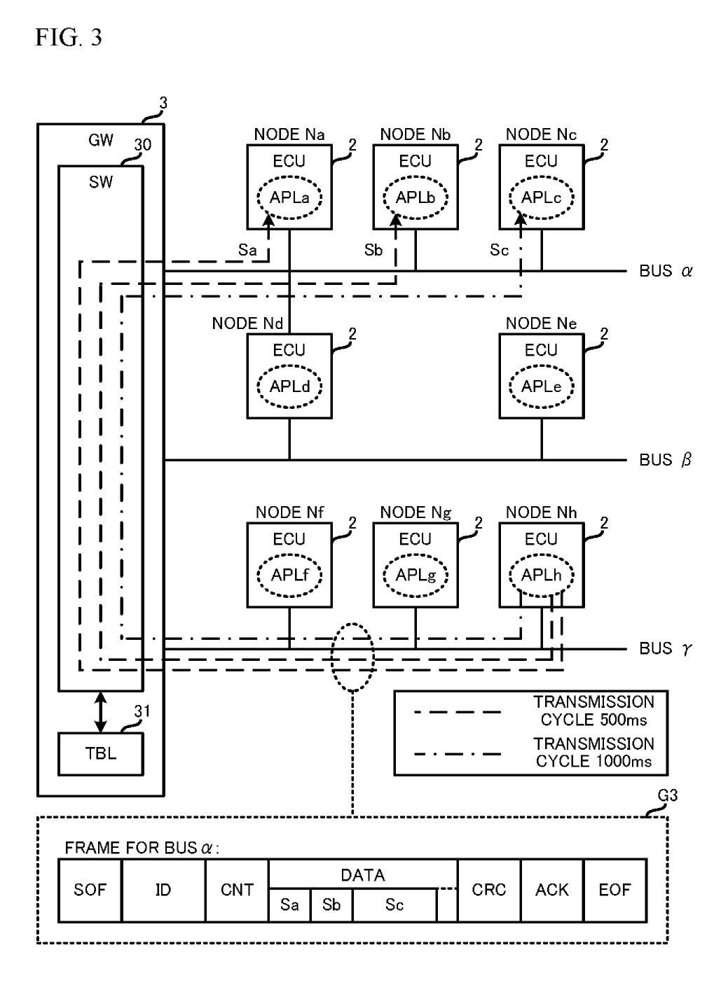

FIG. 3 is a block diagram illustrating the CAN and an accommodation example 3 of the signals. Elements corresponding to those in FIG. 1 are denoted by the same reference numerals, and description thereof is omitted. In the present example, the configuration of the CAN and the signals Sa to Sc are the same as those of the above-mentioned accommodation example 2.

The signal accommodation device may accommodate other signal Sc having a longer transmission cycle than the signals Sa and Sb into the same frame, with respect to the signals Sa to Sc to be transmitted to the destination nodes connected to the same bus α. It is assumed that the data domain of the frame is 64 (bits), and the signals Sa and Sb having the same size (8 bits) and the same transmission cycle are accommodated into the frame for the bus α. In this case, if the size of the signal Sc is 40 (bits), an unused space in the data region of the frame is 48 (bits) (=64−8×2), and hence the signal Sc can be accommodated into the data region. In this case, the transmission cycle of the signal Sc is longer than the transmission cycles of the signals Sa and Sb, and hence a problem does not occur in the process executed by the application APLc receiving the signal Sc.

Therefore, the signal accommodation device accommodates the signals Sa to Sc having different transmission cycles into the single frame by using the unused space in the data region of the frame as illustrated by a code G3, so that the load of the network can be reduced.

### ACCOMMODATION EXAMPLE 4

FIG. 3 is a block diagram illustrating the CAN and an accommodation example 4 of the signals. Elements corresponding to those in FIG. 1 are denoted by the same reference numerals, and description thereof is omitted. In the present example, the configuration of the CAN is the same as that of the CAN of the above-mentioned accommodation example 1.

The ECU 2 of the node Nh transmits the signal Sa to the ECU 2 of the node Na, transmits the signal Sb to each ECU 2 of the nodes Nb and Nd, and transmits the signal Sc to the ECU 2 of the node Ne. Since the destination node Nd of the signal Sb is connected to the two buses α and β, the ECU 2 of the node Nd can receive the signal Sb from any one of the buses α and β. However, since the other destination node Nb of the signal Sb is connected only to the bus α, when the ECU 2 of the node Nd receives the signal Sb from the bus α, the number of destination buses in the frame accommodating the signal Sb can be reduced.

Therefore, the signal accommodation device accommodates, into the same frame, the signal Sb in which the destination node is the node Nd connected to the two buses α and β and the node Nb connected to the single bus α, and the other signal Sa in which the destination node is the node Na connected to the bus α common to the nodes Nd and Nb. More specifically, the signal accommodation device accommodates the signals Sa and Sb into a frame #1 for the bus α, and accommodates the signal Sc into a frame #2 for the bus β, as illustrated by a code G4. Here, in the present example, the node Nd is an example of a first node, and the node Nb is an example of a second node.

Therefore, the number of destination buses in the frame accommodating the signal Sb reduces, compared with a case where the signal Sb is separately accommodated into the frames #1 and #2 for different destination buses α and β. Consequently, the load of the network is reduced.

Next, a description will be given of the configuration of the signal accommodation device.

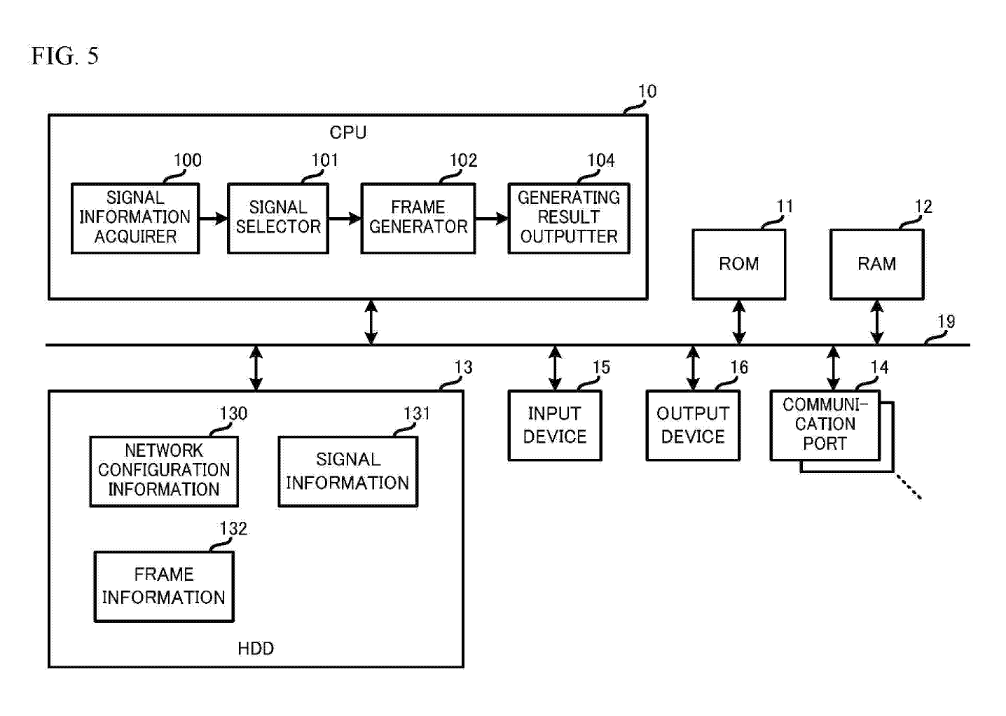

FIG. 5 is a block diagram illustrating an example of the signal accommodation device. For example, a server is given as the signal accommodation device, but the signal accommodation device is not limited to this.

The signal accommodation device includes a CPU 10, a ROM (Read Only Memory) 11, a RAM (Random Access Memory) 12, a HDD (Hard Disk Drive) 13, a plurality of communication ports 14, an input device 15, and an output device 16. The CPU 10 is connected to the ROM 11, the RAM 12, the HDD 13, the plurality of communication ports 14, the input device 15 and the output device 16 via a bus 19 so as to be capable of inputting and outputting the signal each other.

A signal accommodation program for driving the CPU 10 is stored into the ROM 11. The signal accommodation program causes the CPU 10 to execute a signal accommodation method that accommodates the signal into the frame. The RAM 12 functions as a working memory for the CPU 10. The communication ports 14 are a NIC (Network Interface Card), for example, and processes the communication with other devices.

The input device 15 inputs information to the signal accommodation device. For example, a keyboard, a mouse, a touch panel or the like is given as the input device 15. The input device 15 outputs input information to the CPU 10 via the bus 19.

The output device 16 outputs information on the signal accommodation device. For example, a display, a touch panel, a printer or the like is given as the output device 16. The output device 16 acquires information from the CPU 10 via the bus 19 to output the acquired information.

The CPU 10 is an example of a computer. When the CPU 10 reads out a program from the ROM 11, the CPU 10 forms a signal information acquirer 100, a signal selector 101, a frame generator 102, a generating result outputter 104, as functions. Moreover, network configuration information 130, signal information 131, and frame information 132 are stored into the HDD 13. A nonvolatile memory such as an EPPROM (Erasable Programmable ROM) may be used as a storing means storing the network configuration information 130, the signal information 131, and the frame information 132 as substitute for the HDD 13.

The network configuration information 130 and the signal information 131 may be input from the input device 15, or may be received from other device via the communication port 14, for example. The frame information 132 is generated by the frame generator 102, and are written into the HDD 13.

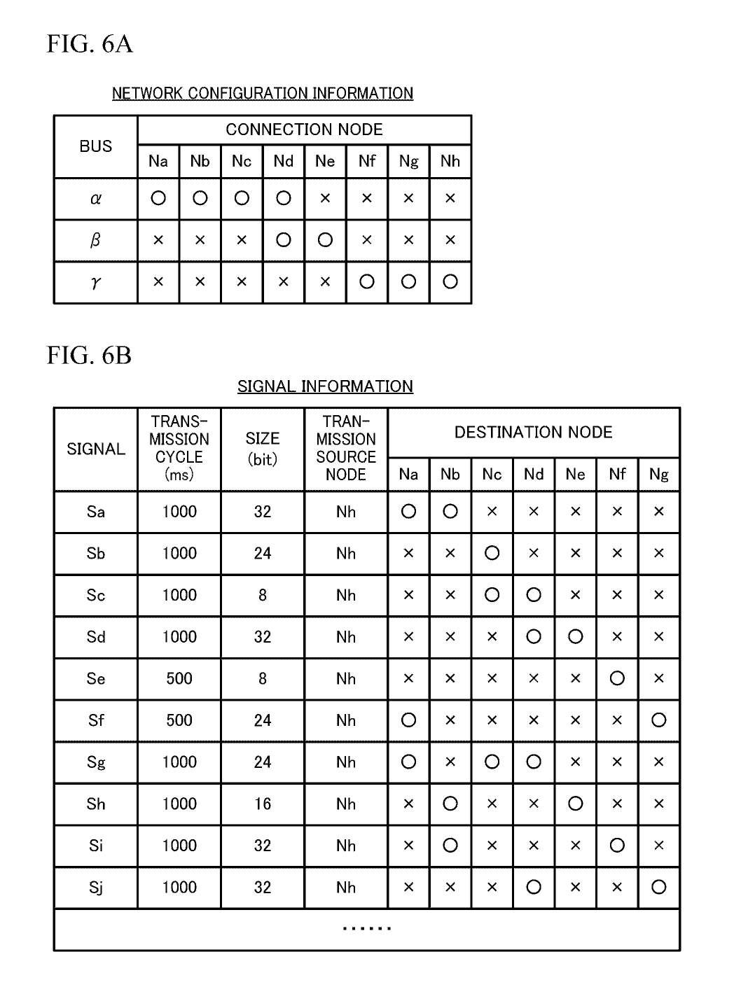

FIG. 6A illustrates an example of the network configuration information 130 and FIG. 6B illustrates an example of the signal information 131. Connection nodes for each of the buses α, β and γare illustrated in the network configuration information 130. A circle mark (see “∘”) means that it corresponds to a connection node, and an X mark (see “x”) means that it does not correspond to the connection node.

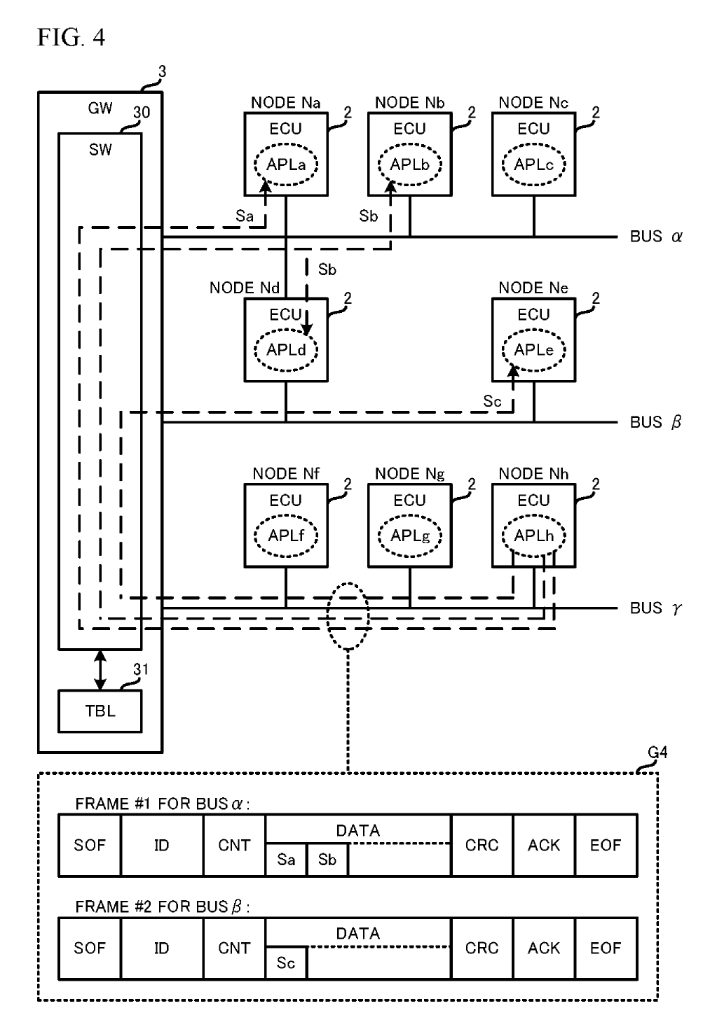

Therefore, the network configuration information 130 illustrates that the connection nodes of the bus α are nodes Na to Nd, the connection nodes of the bus β are nodes Nd and Ne, and the connection nodes of the bus γ are nodes Nf to Nh. Here, this configuration is the configuration of the CAN illustrated in FIGS. 1 to 4 and the following explanation is given with the assumption of this configuration.

The signal information 131 is information on the signals Sa to Sj transmitted and received between the ECUs 2 of the respective nodes Na to Nh. For example, information on a transmission cycle (ms), a size (bit), a transmission source node and a destination node of the signals Sa to Sj is included in the signal information 131.

With respect to the destination node, a circle mark (see “∘”) means that a corresponding node with the circle mark corresponds to the destination node, and an X mark (see “x”) means that the corresponding node with the X mark does not correspond to the destination node. Here, in FIG. 6B, the signals Sa to Sj of the transmission source node Nh are illustrated, and the signals of the other transmission source node Na to Ng are also registered in the signal information 131.

Referring to FIG. 5 again, the signal information acquirer 100 acquires the signal information 131 from the input device 15 or the communication port 14 and writes the signal information 131 into the HDD 13. When the signal information acquirer 100 acquires the signal information 131, the signal information acquirer 100 notifies the signal selector 101 of the acquisition of the signal information 131.

The signal selector 101 selects the plurality of signals Sa to Sj transmitted from one of the nodes Na to Nh. The signal selector 101 selects the signals Sa to Sj transmitted from one of the transmission source nodes Na to Nh designated by an operation from the input device 15, based on the signal information 131, and generates a signal list in which the selected signals Sa to Sj are registered. The signal selector 101 outputs the generated list to the frame generator 102.

The frame generator 102 generates the frame information 132 indicating the signals Sa to Sj to be accommodated into the frame from the signal list. More specifically, the frame generator 102 assigns the signals Sa to Sj to be accommodated to the frame as described in the above-mentioned accommodation examples 1 to 4, as an example of an accommodation part. Thereby, the generated frame information 132 is written in the HDD 13.

The frame generator 102 specifies the signals having the same destination bus α, β and γfrom the signals Sa to Sj selected by the signal selector 101, and accommodates the specified signals into a common frame. That is, the frame generator 102 specifies the signals to be transmitted to the destination nodes connected to the same bus from among the signals Sa to Sj to be transmitted from any one of the nodes selected by the signal selector 101, and accommodates the specified signals into the same frame.

Alternatively, the frame generator 102 specifies the signals having the same destination bus α nd the same transmission cycle from the signals Sa to Sj selected by the signal selector 101, and accommodates the specified signals into the common frame. That is, the frame generator 102 accommodates the signals having the same transmission cycle from among the signals Sa to Sj to be transmitted to the destination nodes connected to the same bus, into the same frame. Therefore, the number of frames in the CAN is reduced, and hence the load of the network can be reduced.

Alternatively, the frame generator 102 may specify other signal having the longer transmission cycle than the signals accommodated in the frame from among the signals Sa to Sj selected by the signal selector 101, and accommodate the other signal into the same frame. That is, the frame generator 102 may accommodate the other signal having the longer transmission cycle than the signals accommodated in the frame from among the signals Sa to Sj to be transmitted to the destination nodes connected to the same bus, into the same frame. In this case, the number of frames in the CAN is further reduced, and hence the load of the network can be reduced.

The signals selected by the signal selector 101 might include the signal Sb having the node Nd connected to the two buses α and β and the node Nb connected to the bus α as the destination nodes, as described in the above-mentioned accommodation example 4. In this case, the frame generator 102 accommodates the signal Sb into the frame in common with other signal Sa in which the node Na connected to the common bus α of the connection nodes Nb and Nd to is made into the destination node.

That is, the frame generator 102 accommodates, into the same frame, the signal Sb having the node Nd connected to the two buses α and β and the node Nb connected to the bus α as the destination nodes, and other signal Sa having the node Na connected to the common bus α of the nodes Nb and Nd as the destination node. Therefore, the number of destination nodes in the frame is reduced, and hence the load of the network can be reduced.

The generating result outputter 104 reads out the frame information 132 generated by the frame generator 102 from the HDD 13, and outputs the frame information 132 from the output device 16 or the communication port 14. The frame information 132 is used for accommodation setting of the signals Sa to Sj of the frame in the CAN illustrated in FIGS. 1 to 4.

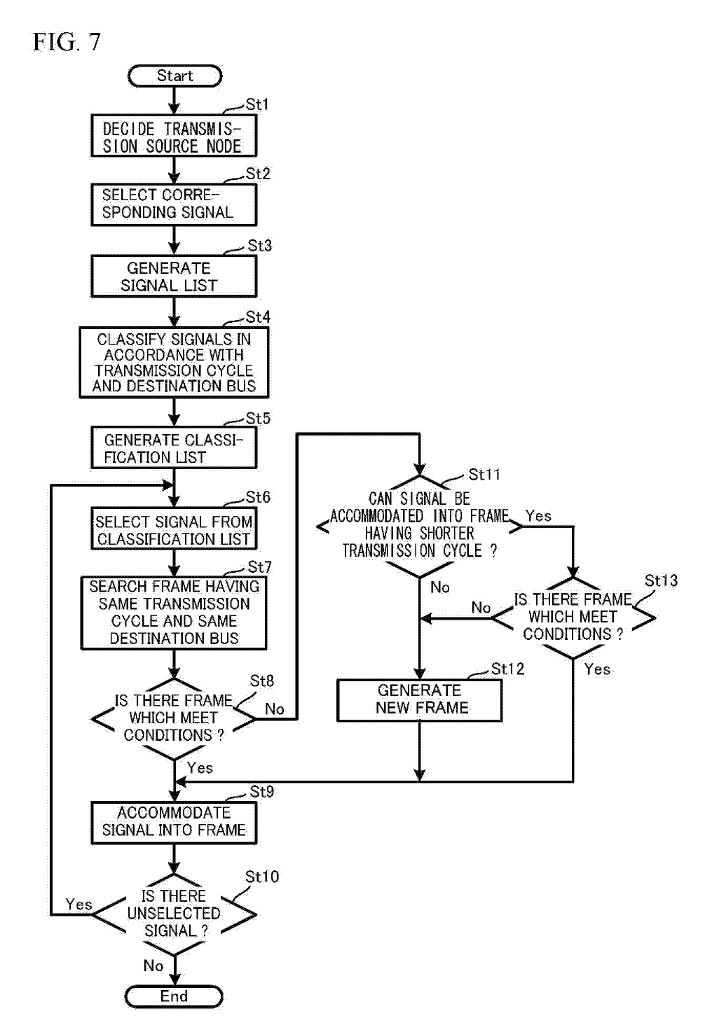

FIG. 7 is a flowchart illustrating an example of a process of a signal accommodation program. The present process is executed by the signal selector 101 and the frame generator 102.

The signal selector 101 decides one of the transmission source nodes Na to Nh which is an object of signal accommodation setting based on an operation input from the input device 15 or designation information received from the communication port 14 (step SU). Next, the signal selector 101 selects one or more signals transmitted from the ECU 2 in one of the transmission source nodes Na to Nh based on the signal information 131 in the HDD 13 (step St2). Next, the signal selector 101 generates the signal list of the selected signals (step St3).

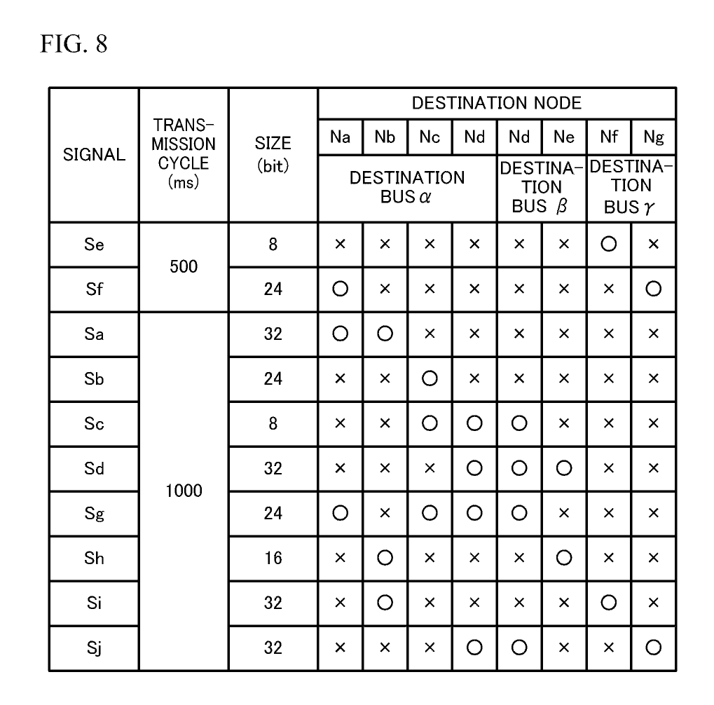

FIG. 8 illustrates an example of the signal list. The example is the signal list generated about the transmission source node Nh based on the signal information 131 of FIG. 6B. The signal list indicates the transmission cycle (ms), the size (bit), the destination node, the destination buses α, β and γ for each of the signals Sa to Sj.

The signal selector 101 sorts the signals Sa to Sj selected based on the signal information 131 in an order having a short transmission cycle, for example. Therefore, in the signal list, the signals Se and Sf having the transmission cycle of 500 (ms) are located above the signals Sa to Sd and Sg to Sj having the transmission cycle of 1000 (ms).

The signal selector 101 searches the connection buses α, β and γ of the destination nodes Na to Nh of the signals Sa to Sj selected based on the signal information 131, from the network configuration information 130. The signal selector 101 adds the searched connection buses α, β and γ to the signal list as the destination buses α, β and γ. Thereby, in the signal list, the destination buses α, β and γ of the signals Sa to Sj are clarified. Since the destination node Nd is connected to two buses α and β, the two destination buses α and β exist.

Referring to FIG. 7 again, the frame generator 102 classifies the signals Sa to Sj in accordance with the transmission cycle and the destination buses α, β and γ based on the signal list (step St4). Next, the frame generator 102 generates a classification list based on a result of the classification (step St5).

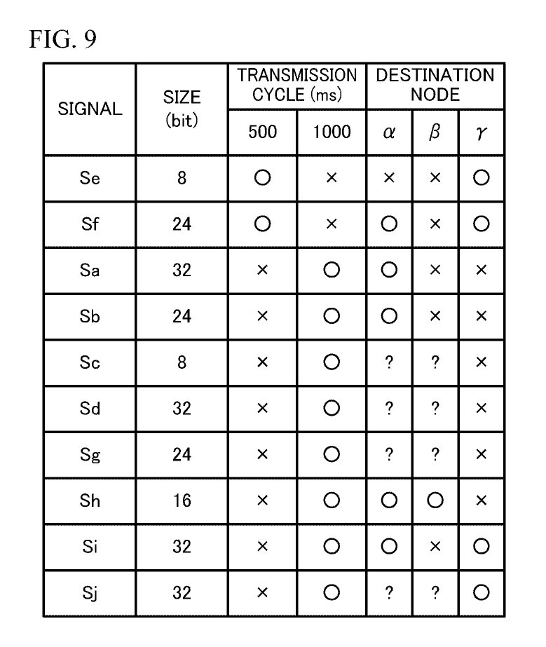

FIG. 9 illustrates an example of the classification list. The size (bit), the transmission cycle (ms) and the destination buses α, β and γ for each of the signals Sa to Sj are registered in the classification list. With respect to the transmission cycle (ms) and the destination buses α, β and γ, a circle mark (see “◯”) means that a corresponding signal has the transmission cycle (ms) and the destination bus with the circle mark, and an X mark (see “x”) means that a corresponding signal has not the transmission cycle (ms) and the destination bus with the X mark.

With respect to the destination buses α, β and γ, a question mark (see “?”) means that the decision of the destination bus α, β and γ is suspended since there are two or more buses α, β and γ. Since each of the signals Sc to Sg and Sj includes the node Nd having the two connection buses α and β as the destination node, the mark “?” is registered in the fields of the destination buses α and β.

However, the registration of the mark “?” is temporary, and the frame generator 102 corrects information on the destination buses α and β with the mark “?”.

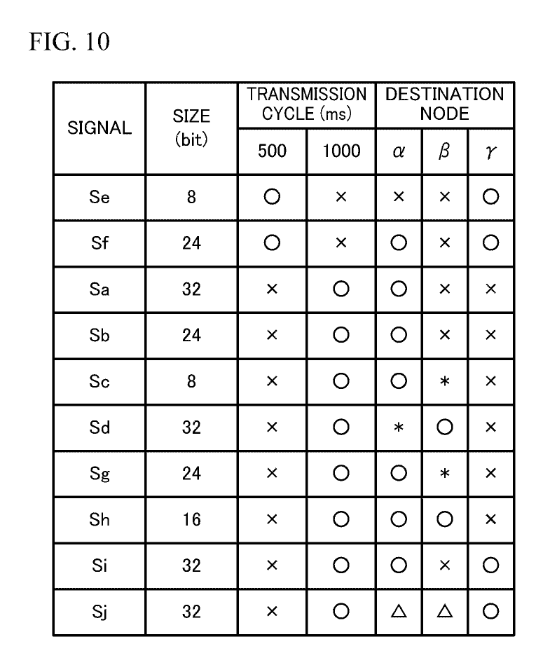

FIG. 10 illustrates an example of the classification list in which the information on the destination buses α and β is corrected. The frame generator 102 corrects the information on the destination buses α and β of the signals Sc to Sg and Sj in which the mark “?” is registered.

The single Sc defines the node Nc as the destination node in addition to the node Nd. Therefore, the signal Sc need to set the connection bus α of the destination node Nc to the destination bus, but need not necessarily to set another bus β of the destination node Nd to the destination bus. Therefore, with respect to the signal Sc, the frame generator 102 sets the destination bus α to “◯ (required)”, and sets the destination bus β to “* (option)”.

The single Sd defines the node Ne as the destination node in addition to the node Nd. Therefore, the signal Sd need to set the connection bus β of the destination node Ne to the destination bus, but need not necessarily to set another bus α of the destination node Nd to the destination bus. Therefore, with respect to the signal Sd, the frame generator 102 sets the destination bus α to “* (option)”, and sets the destination bus β to “(required)”.

The single Sg defines the nodes Na and Nc as the destination nodes in addition to the node Nd. Therefore, the signal Sg need to set the connection bus α of the destination nodes Na and Nc to the destination bus, but need not necessarily to set another bus β of the destination node Nd to the destination bus. Therefore, with respect to the signal Sg, the frame generator 102 sets the destination bus α to “◯ (required)”, and sets the destination bus β to “* (option)”.

The single Sj includes no destination node other than the nodes Nd and Ng. Therefore, the signal Sj need to set the connection bus γ of the destination node Ng to the destination bus, but need not necessarily to set both of the connection buses α and β of the destination node Nd to the destination buses. That is, only any one of the connection buses α and β should become the destination bus of the signal Sj. Therefore, with respect to the signal Sj, the frame generator 102 sets the destination bus γ to “◯ (required)”, and sets the destination buses α and β to “Δ (select one)”.

Referring to FIG. 7 again, the frame generator 102 selects one of the signals Sa to Sj from the classification list (step St6). At this time, the frame generator 102 previously selects the signals Sa, Sb, Se, Sf, Sh or Si without the marks “*” and “Δ”, for example.

Next, the frame generator 102 searches a generated frame having the same transmission cycle and the same destination bus Na to Nh as the selected one of the signals Sa to Sj from the frame information 132 (step St7). Next, the frame generator 102 determines whether there is a frame which meets the above-mentioned conditions in the searched frames (step St8). More specifically, the frame generator 102 determines whether, in the frame having the same transmission cycle and the same destination bus Na to Nh as the selected one of the signals Sa to Sj, the unused space of the data domain of the frame is equal to or more than the size of the selected one of the signals Sa to Sj.

When there is the frame which meets the above-mentioned conditions (YES in step St8), the frame generator 102 accommodates the selected one of the signals Sa to Sj into the frame (step St9). More specifically, the frame generator 102 adds the accommodation information of the selected one of the signals Sa to Sj to the frame registered in the frame information 132.

Next, the frame generator 102 determines whether there is an unselected signal in the signals Sa to Sj (step St10). When there is no unselected signal (NO in step St10), the frame generator 102 finishes the present process. When there is the unselected signal in the signals Sa to Sj (YES in step St10), the frame generator 102 selects the unselected signal (step St6) and executes the process of step St7 again.

When there is no frame which meets the above-mentioned conditions (NO in step St8), the frame generator 102 determines whether to be capable of accommodating the selected one of the signals Sa to Sj into a frame having a shorter transmission cycle than the selected one of the signals Sa to Sj, based on the operation input from the input device 15, for example (step St11). When the frame generator 102 cannot accommodate the selected one of the signals Sa to Sj into the frame (NO in step St11), the frame generator 102 generates a new frame (step St12). More specifically, the frame generator 102 registers the new frame in the frame information 132.

Next, the frame generator 102 accommodates the selected one of the signals Sa to Sj in the generated frame (step St9). More specifically, the frame generator 102 adds the accommodation information of the selected one of the signals Sa to Sj to the new frame registered in the frame information 132. Then, the above-mentioned process of step St10 is performed.

When the frame generator 102 can accommodate the selected one of the signals Sa to Sj into the frame having the shorter transmission cycle than the selected one of the signals Sa to Sj (YES in step St11), the frame generator 102 determines whether there is a frame which meets the above-mentioned conditions, i.e., the frame having the shorter transmission cycle than the selected one of the signals Sa to Sj (step St13). When there is no frame which meets the above-mentioned conditions (NO in step St13), the frame generator 102 executes the above-mentioned process of step St12.

When there is the frame which meets the above-mentioned conditions (YES in step St13), the frame generator 102 accommodates the selected one of the signals Sa to Sj into the frame (step St9). More specifically, the frame generator 102 adds the accommodation information of the selected one of the signals Sa to Sj to the frame registered in the frame information 132. Then, the above-mentioned process of step St10 is performed.

Next, a description will be given of an example of the above-mentioned process of steps St6 to St13.

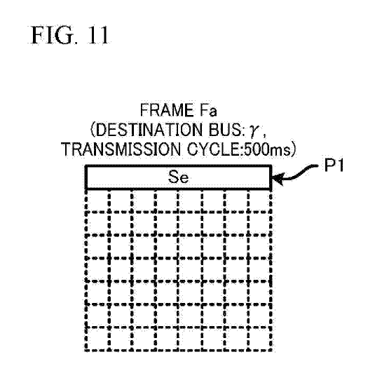

An example of a generating process of the frame information is illustrated in FIGS. 11 to 20 according to time series. FIGS. 11 to 20 illustrates 32-bit data region of the frame by setting each dotted line frame in 1 bit, and a situation where each of the signals Sa to Sj is accommodated into the data region depending on its size. In the present example, the generating process of the frame information is performed based on the classification list of FIG. 10.

In step St6, the frame generator 102 selects the signal Se from the classification list. In step St7, the frame generator 102 searches a frame identical with the destination bus γ and the transmission cycle 500 (ms) of the signal Se from the frame information 132.

The frame is not registered in the frame information 132, so that the frame generator 102 determines in step St8 that there is no frame which meets the above-mentioned conditions (NO in step St8). Here, it is assumed that, in next step Sill, the frame generator 102 determines to be unable to accommodate the signal into the frame (NO in step S11), unless otherwise stated.

In steps St12 and St9, the frame generator 102 generates a frame Fa having the destination bus γ and the transmission cycle 500 (ms) and accommodates the 8-bit signal Se into the frame Fa as illustrated in FIG. 11 (see a code P1). Then, since there are the unselected signals Sa to Sd and Sf to Sj (YES in step St10), the frame generator 102 performs step St6 again.

In next step St6, the frame generator 102 selects the signal Sf from the classification list. In step St7, the frame generator 102 searches a frame identical with the destination buses α and γ and the transmission cycle 500 (ms) of the signal Sf from the frame information 132. The frame which meets the above-mentioned conditions is not registered in the frame information 132, so that the frame generator 102 determines in step St8 that there is no frame which meets the above-mentioned conditions (NO in step St8).

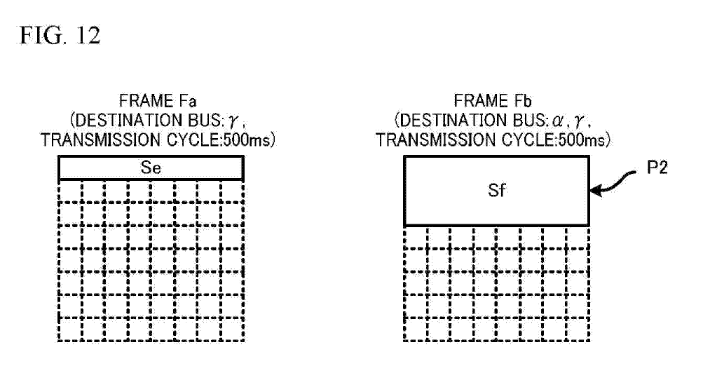

In steps St12 and St9, the frame generator 102 generates a frame Fb having the destination buses α and γ and the transmission cycle 500 (ms) and accommodates the 24-bit signal Sf into the frame Fb as illustrated in FIG. 12 (see a code P2). Then, since there are the unselected signals Sa to Sd and Sg to Sj (YES in step St10), the frame generator 102 performs step St6 again.

In next step St6, the frame generator 102 selects the signal Sa from the classification list. In step St7, the frame generator 102 searches a frame identical with the destination bus α and the transmission cycle 1000 (ms) of the signal Sa from the frame information 132. The frame which meets the above-mentioned conditions is not registered in the frame information 132, so that the frame generator 102 determines in step St8 that there is no frame which meets the above-mentioned conditions (NO in step St8).

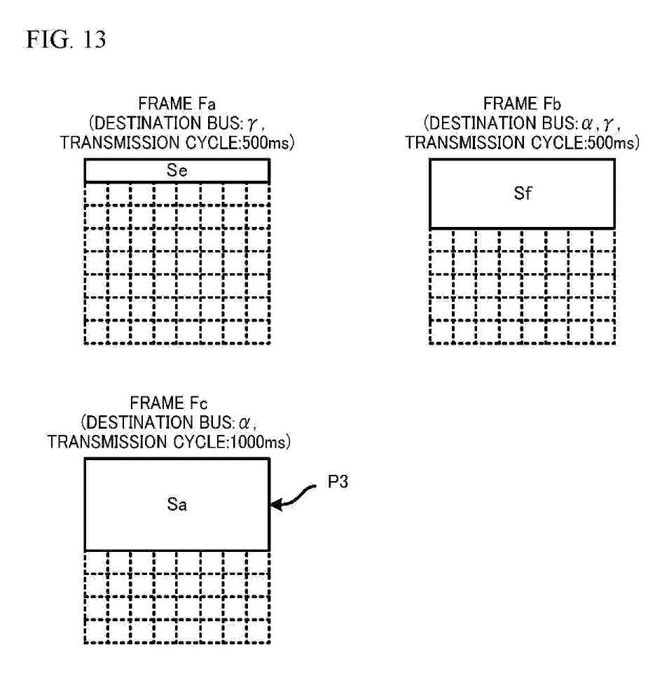

In steps St12 and St9, the frame generator 102 generates a frame Fc having the destination bus α and Δ and the transmission cycle 1000 (ms) and accommodates the 32-bit signal Sa into the frame Fc as illustrated in FIG. 13 (see a code P3). Then, since there are the unselected signals Sb to Sd and Sg to Sj (YES in step St10), the frame generator 102 performs step St6 again.

In next step St6, the frame generator 102 selects the signal Sb from the classification list. In step St7, the frame generator 102 searches a frame identical with the destination bus α and the transmission cycle 1000 (ms) of the signal Sb from the frame information 132. The frame which meets the above-mentioned conditions is already registered in the frame information 132, so that the frame generator 102 determines in step St8 that there is the frame which meets the above-mentioned conditions (YES in step St8).

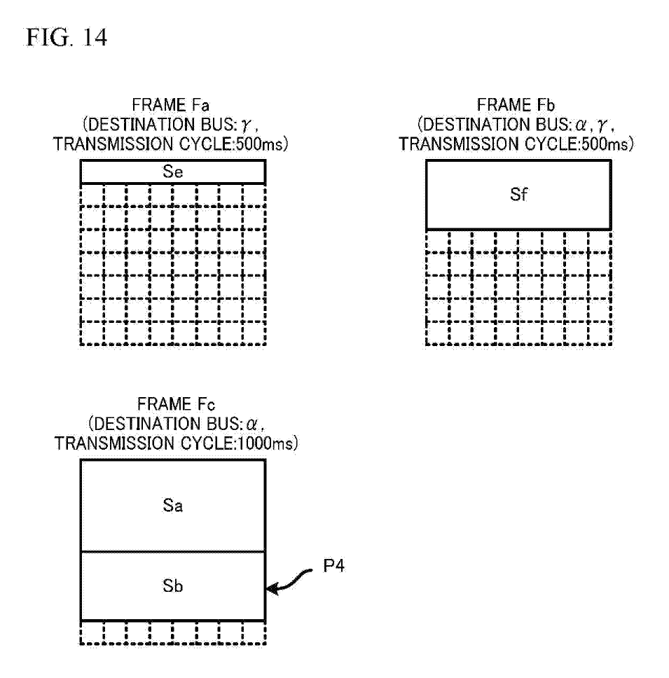

In step St9, the frame generator 102 accommodates the 24-bit signal Sb into the searched frame Fe as illustrated in FIG. 14 (see a code P4). Then, since there are the unselected signals Sc, Sd, and Sg to Sj (YES in step St10), the frame generator 102 performs step St6 again.

Thus, the frame generator 102 specifies the signals Sa and Sb having the same destination bus and the transmission cycle from the plurality of signals Sa to Sj selected by the signal selector 101, and accommodates the signals Sa and Sb into the same flame Fc.

In next step St6, the frame generator 102 selects the signal Sh from the classification list. In step St7, the frame generator 102 searches a frame identical with the destination buses α and β and the transmission cycle 1000 (ms) of the signal Sh from the frame information 132. The frame which meets the above-mentioned conditions is not registered in the frame information 132, so that the frame generator 102 determines in step St8 that there is no frame which meets the above-mentioned conditions (NO in step St8).

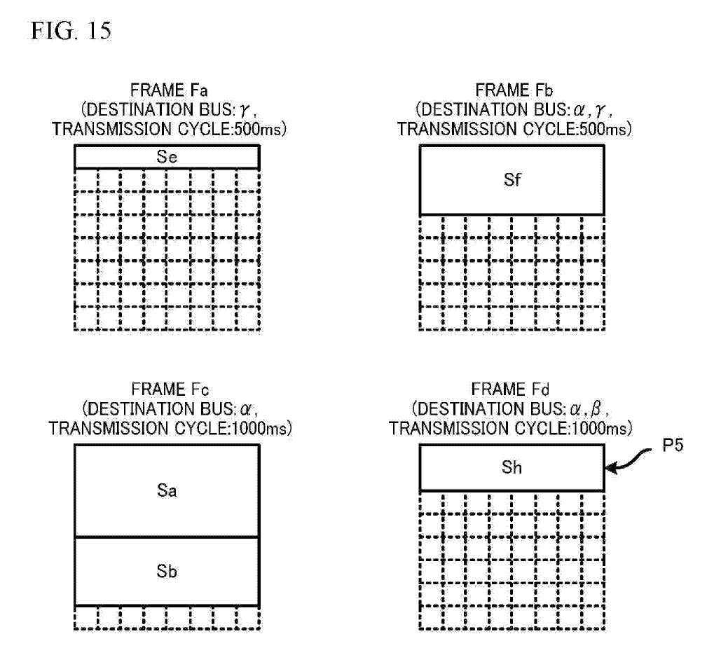

In steps St12 and St9, the frame generator 102 generates a frame Fd having the destination buses α and β and the transmission cycle 1000 (ms) and accommodates the 16-bit signal Sh into the frame Fd as illustrated in FIG. 15 (see a code P5). Then, since there are the unselected signals Sc, Sd, Sg, Si and Sj (YES in step St10), the frame generator 102 performs step St6 again.

In next step St6, the frame generator 102 selects the signal Si from the classification list. In step St7, the frame generator 102 searches a frame identical with the destination buses α and γ and the transmission cycle 1000 (ms) of the signal Si from the frame information 132. The frame which meets the above-mentioned conditions is not registered in the frame information 132, so that the frame generator 102 determines in step St8 that there is no frame which meets the above-mentioned conditions (NO in step St8).

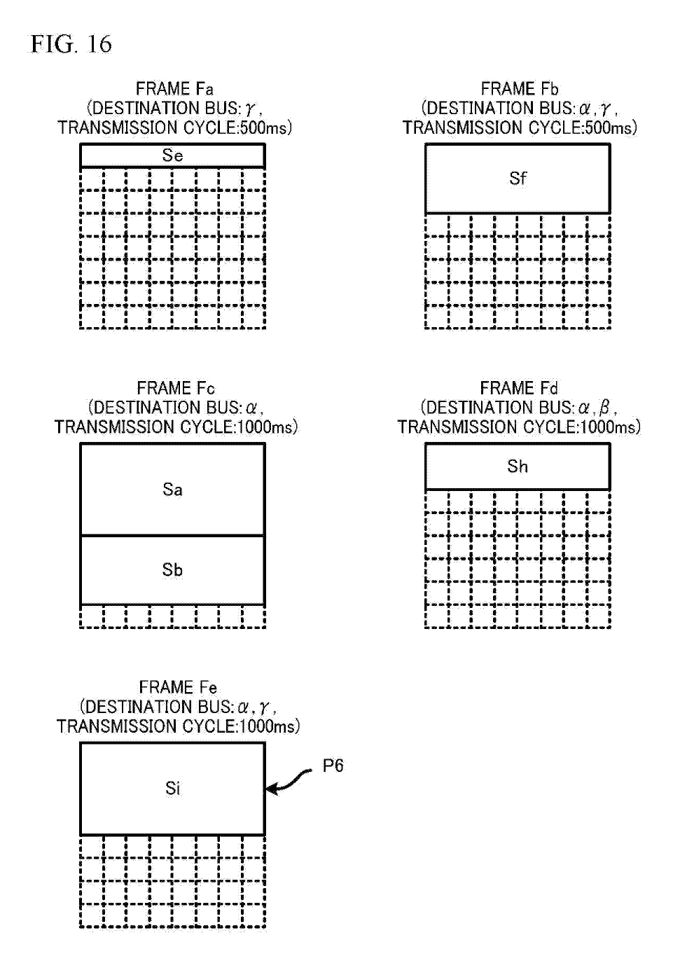

In steps St12 and St9, the frame generator 102 generates a frame Fe having the destination buses α and γ and the transmission cycle 1000 (ms) and accommodates the 32-bit signal Si into the frame Fe as illustrated in FIG. 16 (see a code P6). Then, since there are the unselected signals Sc, Sd, Sg and Sj (YES in step St10), the frame generator 102 performs step St6 again.

In next step St6, the frame generator 102 selects the signal Sc from the classification list. With respect to the signal Sc of the classification list, the mark “◯” is registered in the field of the destination bus α and the mark “*” is registered in the field of the destination bus γ. Therefore, the destination bus of the signal Sc includes two patterns of only the bus α and both of the buses α and β.

Therefore, in step St7, the frame generator 102 searches a frame identical with the destination bus α or the destination buses α and β and the transmission cycle 1000 (ms) of the signal Sc from the frame information 132. The frame Fc which meets the above-mentioned conditions is already registered in the frame information 132, and the unused space (8 bits) of the data domain of the frame is the same as the size (8 bits) of the signal Sc. Therefore, the frame generator 102 determines in step St8 that there is the frame Fc which meets the above-mentioned conditions (YES in step St8).

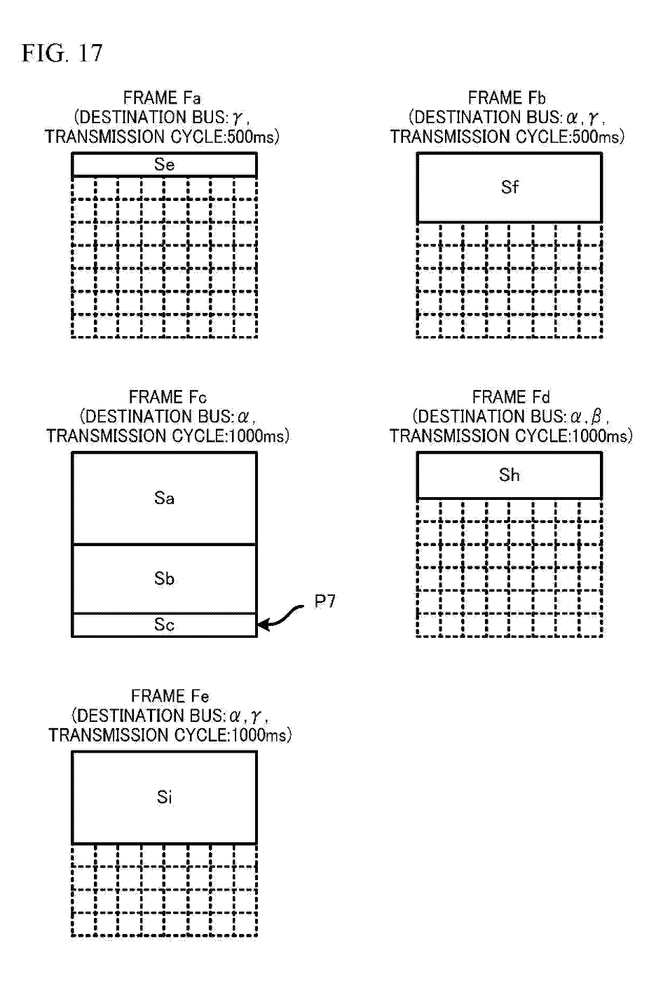

In step St9, the frame generator 102 accommodates the 8-bit signal Sc into the searched frame Fc as illustrated in FIG. 17 (see a code P7). Thus, the frame generator 102 accommodates, into the common frame, the signal Sc including the node Nd connected to the two buses α and β and the node Nc connected to the single bus α as the destination nodes, and the other signals Sa and Sb including the nodes Na to Nc connected to the common bus α of the nodes Nd and Nc as the destination nodes. Then, since there are the unselected signals Sd, Sg and Sj (YES in step St10), the frame generator 102 performs step St6 again.

In next step St6, the frame generator 102 selects the signal Sd from the classification list. With respect to the signal Sd of the classification list, the mark “*” is registered in the field of the destination bus α and the mark “◯” is registered in the field of the destination bus β. Therefore, the destination bus of the signal Sd includes two patterns of only the bus β and both of the buses α and β.

Therefore, in step St7, the frame generator 102 searches a frame identical with the destination bus β or the destination buses α and β and the transmission cycle 1000 (ms) of the signal Sd from the frame information 132. The frame Fd which meets the above-mentioned conditions is already registered in the frame information 132, and the unused space (48 bits) of the data domain of the frame Fd is larger than the size (32 bits) of the signal Sd. Therefore, the frame generator 102 determines in step St8 that there is the frame Fd which meets the above-mentioned conditions (YES in step St8).

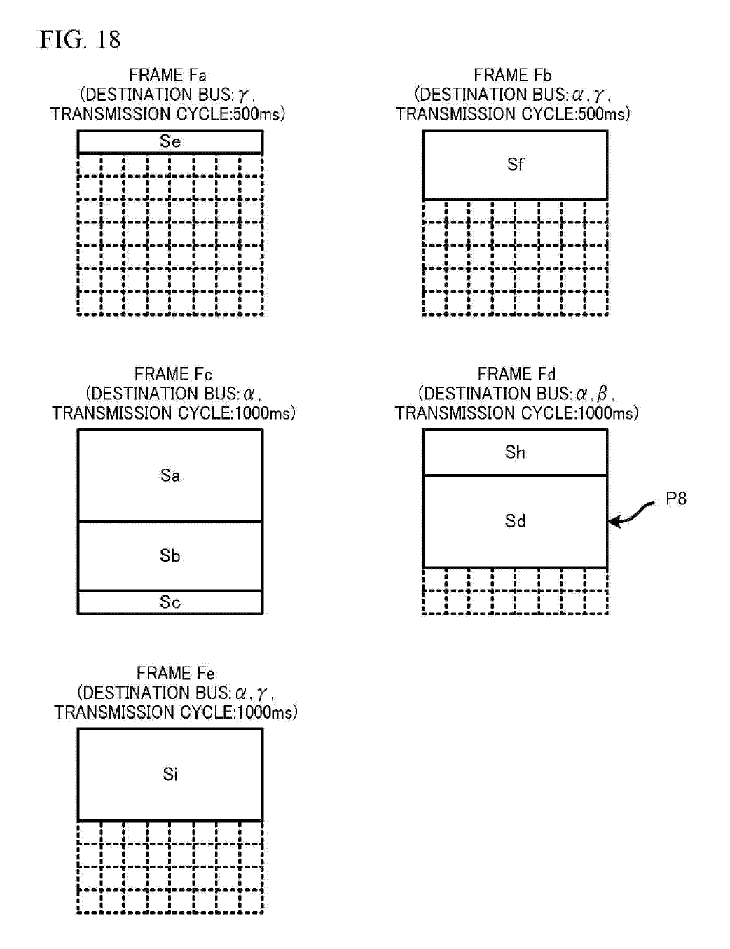

In step St9, the frame generator 102 accommodates the 32-bit signal Sd into the searched frame Fd as illustrated in FIG. 18 (see a code P8). Then, since there are the unselected signals Sg and Sj (YES in step St10), the frame generator 102 performs step St6 again.

In next step St6, the frame generator 102 selects the signal Sg from the classification list. With respect to the signal Sg of the classification list, the mark “◯” is registered in the field of the destination bus α and the mark “*” is registered in the field of the destination bus β. Therefore, the destination bus of the signal Sg includes two patterns of only the bus α and both of the buses α and β.

Therefore, in step St7, the frame generator 102 searches a frame identical with the destination bus α or the destination buses α and β and the transmission cycle 1000 (ms) of the signal Sg from the frame information 132. The frame Fc which meets the above-mentioned conditions is already registered in the frame information 132, but the unused space (0 bit) of the data domain of the frame Fc is smaller than the size (24 bits) of the signal Sg. Moreover, the frame Fd which meets the above-mentioned conditions is already registered in the frame information 132, but the unused space (16 bits) of the data domain of the frame Fd is smaller than the size (24 bits) of the signal Sg.

Moreover, the frame Fe which meets the above-mentioned conditions is already registered in the frame information 132, and the unused space (32 bits) of the data domain of the frame Fe is larger than the size (24 bits) of the signal Sg. Therefore, the frame generator 102 determines in step St8 that there is the frame Fe which meets the above-mentioned conditions (YES in step St8).

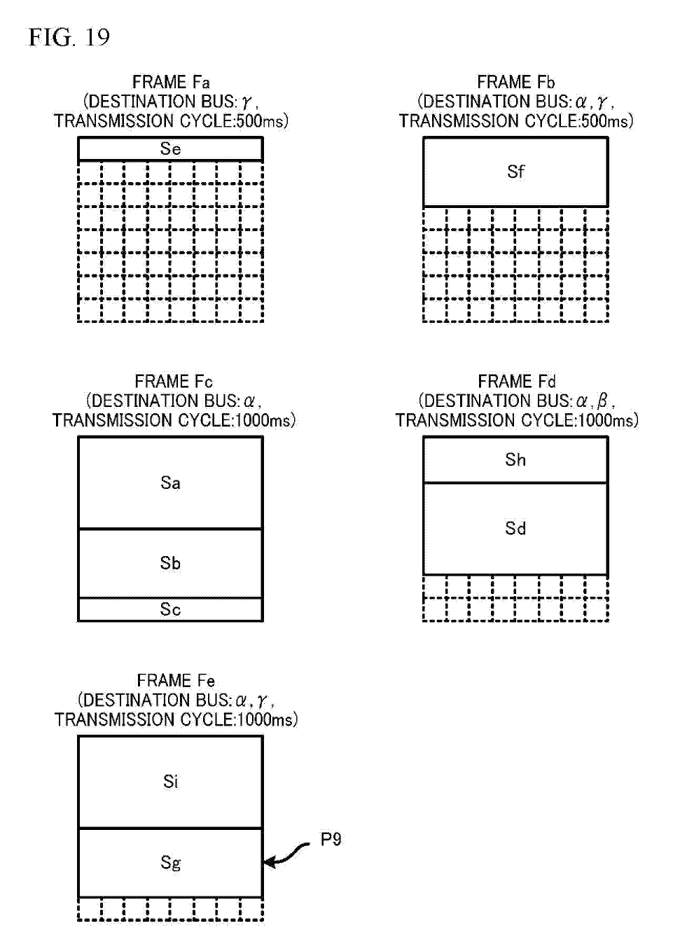

In step St9, the frame generator 102 accommodates the 24-bit signal Sg into the searched frame Fe as illustrated in FIG. 19 (see a code P9). Then, since there is the unselected signal Sj (YES in step St10), the frame generator 102 performs step St6 again.

In next step St6, the frame generator 102 selects the signal Sj from the classification list. With respect to the signal Sj of the classification list, the mark “Δ” is registered in the fields of the destination buses α and β and the mark “◯” is registered in the field of the destination bus γ. Therefore, the destination bus of the signal Sj includes two patterns of both of the buses α and γ and both of the buses α and γ.

Therefore, in step St7, the frame generator 102 searches a frame identical with the destination buses α and γ or the destination buses β and γ and the transmission cycle 1000 (ms) of the signal Sj from the frame information 132. The frame Fe which meets the above-mentioned conditions is already registered in the frame information 132, but the unused space (8 bits) of the data domain of the frame Fe is smaller than the size (32 bits) of the signal Sj. Therefore, the frame generator 102 determines in step St8 that there is no frame which meets the above-mentioned conditions (NO in step St8).

The frame which meets the above-mentioned conditions is not registered in the frame information 132, so that the frame generator 102 determines in step St8 that there is no frame which meets the above-mentioned conditions (NO in step St8). In next step St11, the frame generator 102 determines to be able to accommodate the signal Sj into the frame having the shorter transmission cycle based on the operation input from the input device 15, for example (YES in step S11).

The frame Fb having a shorter transmission cycle than the signal Sj and identical with the destination buses α and γ of the signal Sj is already registered in the frame information 132, and the unused space (40 bits) of the data domain of the frame Fb is larger than the size (32 bits) of the signal Sj. Therefore, the frame generator 102 determines in step St13 that there is the frame Fb which meets the above-mentioned conditions (YES in step St13).

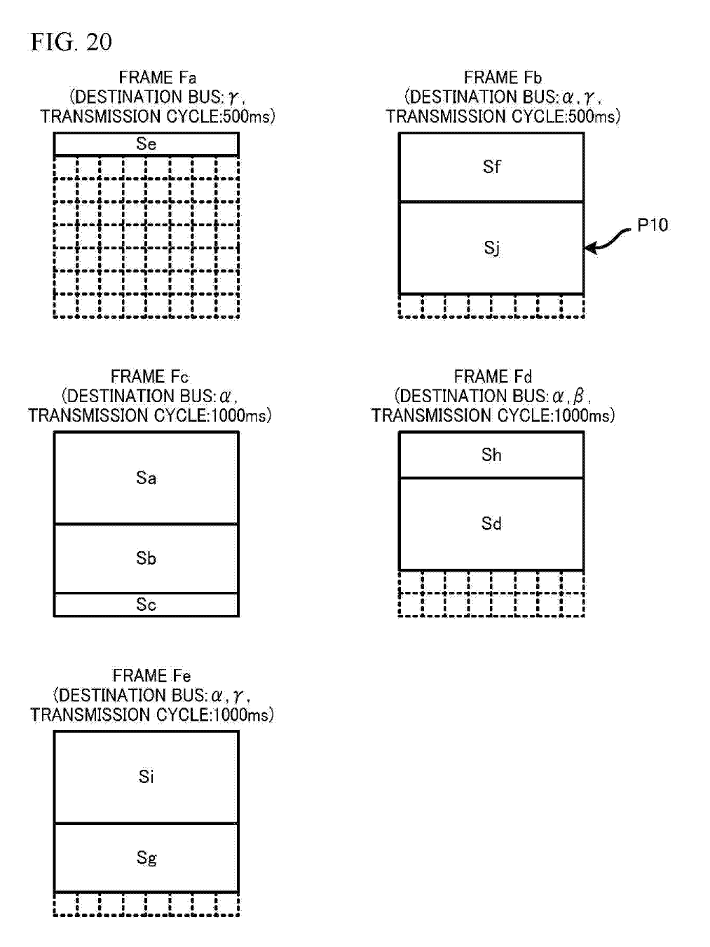

In step St9, the frame generator 102 accommodates the 32-bit signal Sj into the searched frame Fb as illustrated in FIG. 20 (see a code P10). Thus, the frame generator 102 specifies the signal Sj having a longer transmission cycle than the signal Sf accommodated into the frame Fb, and accommodates the signal Sj into the frame Fb. Then, since there is no unselected signal (NO in step St10), the frame generator 102 finishes the process.

In this way, the signal accommodation device performs accommodation design of the signals Sa to Sj. Here, the frame information 132 acquired by the above-mentioned frame generating process is output to the output device 16 by the generating result outputter 104 or is output from the communication port 14 to other device, and is used for the frame setting of the signals Sa to Sj in the CAN.

The above-mentioned processing functions can be realized by a computer. In this case, a program in which the processing contents of the functions which the computer should include is written is provided. By executing the program on the computer, the processing functions are realized by the computer. The program in which the processing contents are written may be recorded on a non-transitory computer-readable recording medium (however, a carrier wave is excluded).

When the program is distributed, a removable recording medium such as a DVD (Digital Versatile Disc) or a CD-ROM (Compact Disc Read Only Memory) in which the program is recorded is sold. Further, the program may be stored in a memory device of a server computer and transferred from the server computer to another computer via a network.

The computer which runs the program, e.g., stores the program recorded in the removable recording medium or transferred from the server computer into a memory device of the computer. Then the computer reads the program from the memory device of the computer, and runs the process according to the program. Incidentally, the computer may read the program directly from the removable recording medium and run the process according to the program. Further, every time the program is transferred from the server computer, the computer may successively run the process according to the received program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A non-transitory computer readable medium storing a signal accommodation program that causes a computer to execute a process comprising:
specifying a plurality of signals to be transmitted to nodes connected to a bus from among signals transmitted from any one of one or more nodes connected to a plurality of buses included in a network; and
accommodating the plurality of signals into a frame to be transferred on the network.

2. The non-transitory computer readable medium as claimed in claim 1, wherein
the accommodating accommodates, into the frame, signals having a same transmission cycle from among the plurality of signals.

3. The non-transitory computer readable medium as claimed in claim 2, wherein
the accommodating accommodates, into the frame, another signal having a longer transmission cycle than the plurality of signals accommodated in the frame.

4. The non-transitory computer readable medium as claimed in claim 1, wherein
the accommodating accommodates, into the frame, a signal to be transmitted to a first node connected to at least two buses and a second node connected to one of the at least two buses, and another signal to be transmitted to a third node connected to the one of the at least two buses.

5. A signal accommodation method implemented by a computer comprising:
specifying a plurality of signals to be transmitted to nodes connected to a bus from among signals transmitted from any one of one or more nodes connected to a plurality of buses included in a network; and
accommodating the plurality of signals into a frame to be transferred on the network.

6. The signal accommodation method as claimed in claim 5, wherein
the accommodating accommodates, into the frame, signals having a same transmission cycle from among the plurality of signals.

7. The signal accommodation method as claimed in claim 6, wherein
the accommodating accommodates, into the frame, another signal having a longer transmission cycle than the plurality of signals accommodated in the frame.

8. The signal accommodation method as claimed in claim 5, wherein
the accommodating accommodates, into the frame, a signal to be transmitted to a first node connected to at least two buses and a second node connected to one of the at least two buses, and another signal to be transmitted to a third node connected to the one of the at least two buses.

9. A signal accommodation device comprising:
a memory; and
a processor coupled to the memory and the processor configured to:
specify a plurality of signals to be transmitted to nodes connected to a bus from among signals transmitted from any one of one or more nodes connected to a plurality of buses included in a network; and
accommodate the plurality of signals into a frame to be transferred on the network.

10. The signal accommodation device as claimed in claim 9, wherein
the processor accommodates, into the frame, signals having a same transmission cycle from among the plurality of signals.

11. The signal accommodation device as claimed in claim 10, wherein
the processor accommodates, into the frame, another signal having a longer transmission cycle than the plurality of signals accommodated in the frame.

12. The signal accommodation device as claimed in claim 9, wherein
the processor accommodates, into the frame, a signal to be transmitted to a first node connected to at least two buses and a second node connected to one of the at least two buses, and another signal to be transmitted to a third node connected to the one of the at least two buses.
